(19) United States
(12) Patent Application Publication
(10) Pub. No.: US 2018/0320922 A1
(43) Pub. Date: Nov. 8, 2018

(54) APPARATUS FOR NATURAL VENTILATION OF A ROOM HAVING A VENTILATION PASSAGE COMBINED WITH A NOISE ABSORBER

(71) Applicants: Christian CARME, Marseille (FR); TECHNOFIRST, Aubagne (FR)

(72) Inventor: Christian CARME, Marseille (FR)

(21) Appl. No.: 15/772,890

(22) PCT Filed: Nov. 2, 2016
(86) PCT No.: PCT/FR2016/052836

§ 371 Date: May 2, 2018

(30) Foreign Application Priority Data
Nov. 2, 2015 (FR) 1560495

(51) Int. Cl. F24F 13/18; F24F 13/24

(52) U.S. Cl. CPC F24F 13/18; G10K 11/178; F24F 13/24

(57) ABSTRACT

An apparatus for natural ventilation of a room, including a room, at least one door or one window that has an opening frame produced by profiles supporting at least one glass panel, which opening frame is mounted so as to move in a fixed stationary frame formed by profiles surrounding said opening frame, a ventilation passage which communicates between the outside of the room and the inside of the room in such a way as to allow natural ventilation between the outside and inside of said room, and a noise absorber capable of attenuating sound waves propagating in the ventilation passage.

### TECHNICAL FIELD OF THE INVENTION

The invention has for object an apparatus for natural ventilation of a room having a ventilation passage associated with a noise absorber.

It relates to the technical field of particular arrangements that make it possible to provide natural ventilation of a room through a door or a window.

### PRIOR ART

It is known through patent documents US2014/0113541 (DRIER), U.S. Pat. No. 6,648,750 (WISEMAN) and WO 2004/070155 (HARDING), ventilation assemblies for buildings comprising a ventilation passage installed on a door or a window.

This ventilation passage communicates between the outside of the building and the inside of said building in such a way as to allow natural ventilation between the outside and the inside of said building. More precisely, it has a first end, closed by a trapdoor and opening into the building, and a second end opening to the outside of said building.

In the WISEMAN apparatus, a noise absorber is installed in the ventilation passage in order to reduce the noise. The absorber comprises at least one control microphone installed to sense the noise in the ventilation passage, and at least one loudspeaker provided with a vibrating membrane suitable for generating a counter-noise in the ventilation passage in response to the noise sensed by the control microphone.

The WISEMAN apparatus has several disadvantages. First of all, it is necessary to provide a trapdoor in order to free the first end of the ventilation passage and initiate natural ventilation. The manipulation and the access to this trapdoor are not necessarily easy for certain people, in particular the elderly. Furthermore, this trapdoor can be the source of a heat loss detrimental to the insulation of the building.

Furthermore the apparatus is complex to realize and to install. Indeed, the ventilation passage is either installed in the opening frame of the door or of the window, or between the stationary frame and a bearing wall. It is therefore necessary to provide substantial modifications on the opening frames of the door or of the window and/or a bearing structure for the setting up of the ventilation passage.

The invention aims to overcome this situation. In particular, an objective of the invention is to simplify the design of the ventilation passage as well as the manipulation thereof.

Another objective of the invention is to reduce the risks of a heat leak at the ventilation passage.

Yet another objective of the invention is to simplify the setting up of the ventilation passage.

### DISCLOSURE OF THE INVENTION

The solution proposed by the invention is an apparatus for the ventilation of a room, said apparatus comprising:
a room delimited by walls,
at least one door or one window installed in one of the room walls and comprising an opening frame produced from profiles supporting at least one glass panel, which opening frame is mounted so as to move in a fixed stationary frame formed by profiles surrounding said opening frame,
a ventilation passage which communicates between the outside of the room and the inside of the room in such a way as to allow natural ventilation between the outside and inside of said room,
a noise absorber capable of attenuating sound waves propagating in the ventilation passage, said attenuation being realized by the generation of a counter-noise which is superimposed on said sound waves,
the opening frame is mounted movably in the stationary frame between a closed position wherein a first profile of the opening frame is attached to the first corresponding profile of the stationary frame and an open position wherein the first profile of the opening frame is separated from the first profile of the stationary frame.

This installation is remarkable in that:
in an intermediate open position, the first profile of the opening frame is separated from the first profile of the stationary frame by a predetermined distance,
the ventilation passage is delimited by the space separating the first profile of the opening frame from the first profile of the stationary frame when said opening frame is in the intermediate open position,
the noise absorber is directly installed in the first profile of the opening frame and/or in the first profile of the stationary frame,
when the opening frame is in the closed position, the first profiles are attached together in such a way that the ventilation passage is hermetically closed, with any ventilation between the inside and outside of the room by said ventilation passage being prevented.

It is therefore now by simply and directly manipulating the door or the window, that the user can allow or prevent the natural ventilation through the ventilation passage. In addition, it is no longer necessary to provide a trapdoor as in the WISEMAN apparatus, which simplifies the design of the ventilation passage. Furthermore, the profiles of the opening and stationary frames hermetically closing the ventilation passage, heat losses are reduced, and even zero, at this level.

Other advantageous characteristics of the invention are listed hereinbelow. Each one of these characteristics can be considered alone or in combination with the remarkable characteristics defined hereinabove, and be the object, where applicable, of one or several divisional patent applications:
The first profiles are advantageously vertical profiles.
The noise absorber can be directly installed in the first profile of the stationary frame; with the corresponding first profile of the opening frame having a face which is located facing the noise absorber, which face is covered with a sound-insulating material.
In an alternative embodiment, the noise absorber can be directly installed in the first profile of the opening frame; with the corresponding first profile of the stationary frame having a face which is located facing the noise absorber, which face is covered with a sound-insulating material.
The noise absorber advantageously comprises at least one microphone arranged to sense the noise in the ventilation passage and at least one loudspeaker adapted to generate a counter-noise in the ventilation passage in response to the noise sensed by the microphone.
A switch can be adapted to activate the noise absorber.
This switch can be adapted to be controlled by the movement of the opening frame in such a way that when said opening frame passes from the closed position to the intermediate open position, said switch automatically activates the noise absorber.
The switch can also be adapted to automatically deactivate the noise absorber when the opening frame is in the closed position.
The microphone is preferably installed on the same profile as the one in which the loudspeaker is installed, said microphone being adjacent to said loudspeaker.
The microphone can be a control microphone connected to a control electronics, the latter being adapted to control the loudspeaker according to the acoustic signals sensed by the control microphone, which control electronics comprises a means of filtering via feedback having an input connected to the control microphone and an output connected to the loudspeaker.
The control microphone is advantageously offset from the longitudinal median plane of the profile whereon it is installed, opposite the noise source to be attenuated.
The control microphone is advantageously oriented in a direction which is perpendicular to the direction of propagation, in the ventilation passage, of the acoustic signals coming from the noise source to be attenuated.
At least one reference microphone can be installed outside of the ventilation passage, which microphone is oriented towards the noise source, the control electronics comprising a means of filtering by feedforward, having an input (connected to the reference microphone and an output connected to the loudspeaker.
The control microphone and the reference microphone are advantageously carried by the same profile or are each carried by a separate profile.
Advantageously, the control electronics comprises a summing means having a first input, a second input and an output connected to the loudspeaker; the means of filtering via feedback comprises an input connected to the control microphone and an output connected to the first input of the summing means; the means of filtering via feedforward comprises an input connected to the reference microphone and an output connected to the second input of the summing means.
The means of filtering by feedforward is preferably of the adaptive type and comprises: —a first input connected to the control microphone; —a second input connected to the reference microphone.
The loudspeaker can be a circular loudspeaker or a linear loudspeaker.

### DESCRIPTION OF THE FIGURES

Other advantages and characteristics of the invention shall appear when reading the following description of a preferred embodiment, in reference to the annexed drawings, realized by way of indicative and non-limiting examples and wherein:

FIG. 1 is a diagrammatical front view, from the outside of the room, of an apparatus in accordance with the invention according to a first embodiment, with the window in the closed position,

FIG. 2 is a diagrammatical view as a cross-section according to A-A of the apparatus of FIG. 1,

FIG. 3 is a diagrammatical front view, from the outside of the room, of the apparatus according to the first embodiment, with the window in the intermediate open position,

FIG. 4 is a diagrammatical view as a cross-section according to B-B of the apparatus of FIG. 3,

FIG. 5 is a cross-section diagrammatical view of an apparatus in accordance with the invention according to a second embodiment, with the window in the closed position,

FIG. 6 shows the apparatus of FIG. 5 with the window in the intermediate open position,

FIG. 7 shows an embodiment and an arrangement of an active noise absorber,

FIG. 8 shows another embodiment and an arrangement of an active noise absorber,

FIG. 9 shows an embodiment and an arrangement of an active noise absorber.

FIG. 10 shows an embodiment and an arrangement of a passive noise absorber.

### PREFERRED EMBODIMENTS OF THE INVENTION

This invention relates to an apparatus for natural ventilation of a room, which is characterized by a particular design of the ventilation passage and of the noise absorber that it comprises.

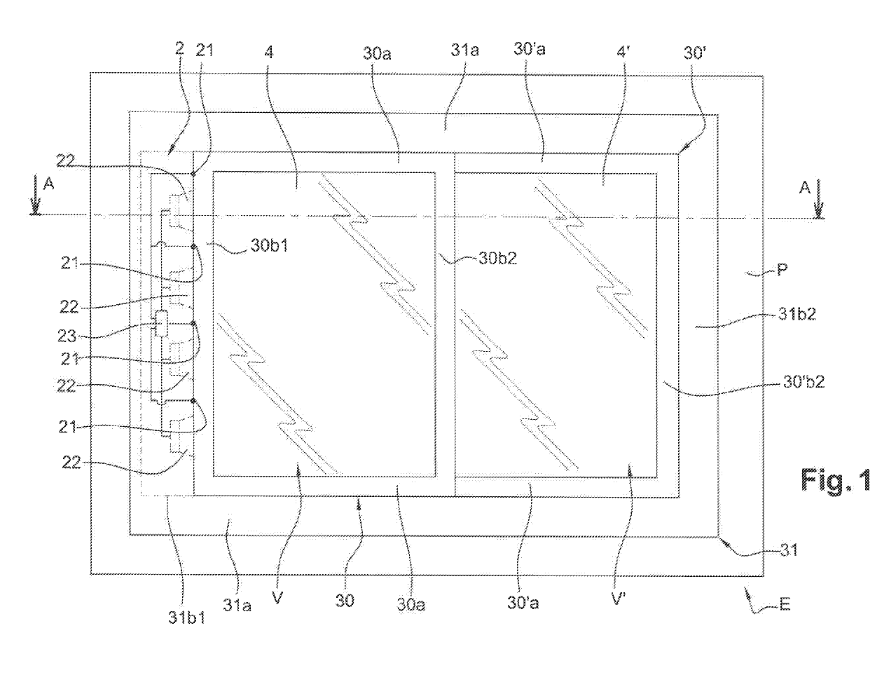

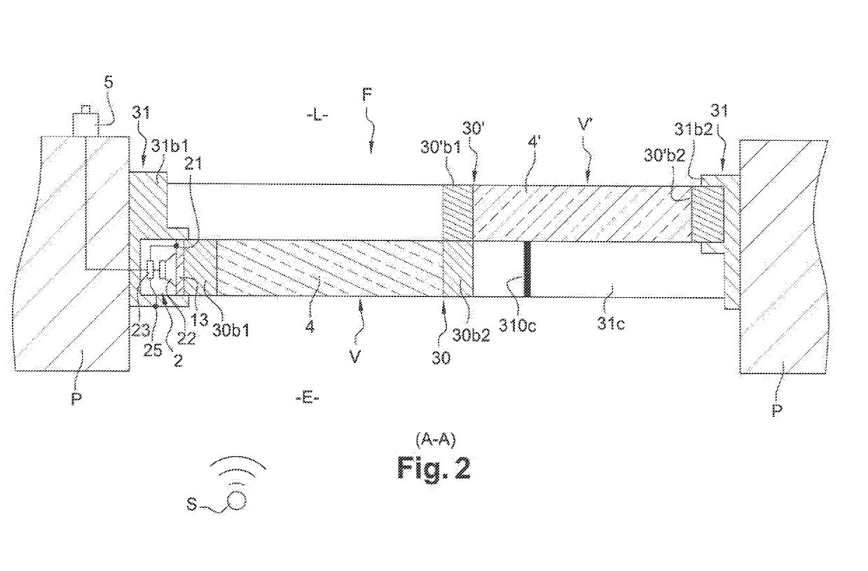

In relation to FIGS. 1 and 2, the apparatus comprises a room L delimited by walls P. This room can be a room in a residence or an office. In this case, the walls P are typically bearing walls.

At least one door or one window F is installed in one of the room L walls P. In order to simplify the understanding of the invention, the rest of the description focuses only on a window F.

This window F is preferably a multi-glazed window, for example double glazing, but can be with single glazing. It forms an interface between the inside of the room L and the outside of said room.

The window F itself is of a known type. It is comprised of one or several leaves V, V′ as shown in FIG. 1. Each leaf V, V′ is comprised of an opening frame 30, 30′ (simply referred to as “opening” in carpentry) formed by horizontal 30a, 30′a and vertical 30b1, 30b2, 30′b1, 30′b2 profiles surrounding at least one glass panel 4, 4′. The opening frames 30, 30′ have a general rectangular shape, which borders the respective panels 4, 4′ according to the four sides thereof. They are more preferably identical.

The opening frames 30, 30′ are mounted movable in a stationary frame 31 (simply referred to as “stationary” in carpentry) fixed to the wall P. This stationary frame 31 is integral with the wall P and more generally with the structural work or with the frame of the assembly where the window must be arranged F. It is also formed by horizontal 31a and vertical 31b1, 31b2 profiles surrounding the opening frames 30, 30′.

In the case where the opening is formed of two leaves V, V′, the dimensions of the opening frames 30, 30′ in width are substantially equal to half of that of the stationary frame 31 that surrounds them. Their dimensions in height are substantially equal to that of the stationary frame 31, to the nearest profile thicknesses. By way of an illustrative example only, the opening frames 30, 30′ have a width of 1.5 m and a height of 2.5 m.

The profiles 30a, 30′a, 30b1, 30b2, 30′b1, 30′b2, 31a, 31b1, 31b2 are rigid, made from metal such as aluminum or other, wood, plastic material, even by combining such materials.

In FIGS. 1 to 6, the window F is a sliding window. At least the leaf V is able to be displaced by laterally sliding over at least one horizontal support rail 31c mounted in the stationary frame 31, and in particular in its lower portion. The opening frame 30 can include one or several wheel or roller carriages, able to provide the sliding thereof in the rail 31c.

Conventionally, the opening frame 30 is movable between a closed position (FIGS. 1, 2 and 5) wherein it closes the stationary frame 31 and an open position wherein it frees. The open position provides a natural ventilation between the inside and outside E the room L. In the closed position, the two leaves V, V′ are in the extension of one another, while in the open position they are superimposed.

In the closed position, the lateral vertical profile 30b1 of the opening frame 30 penetrates into the corresponding vertical profile 31b1 of the stationary frame 31, with these two profiles being hermetically attached. Preferably, these two profiles 30b1, 31b1 include mutual means of locking for blocking the leaf V in this position. Typically, in the closed position, no ventilation between the inside and outside E the room L, is possible by the window F.

In the open position, the lateral vertical profile 30b1 of the opening frame 30 is detached from the corresponding vertical profile 31b1 of the stationary frame 31, and is separated from the latter. Natural ventilation is possible between the inside and outside E the room L, by the window F.

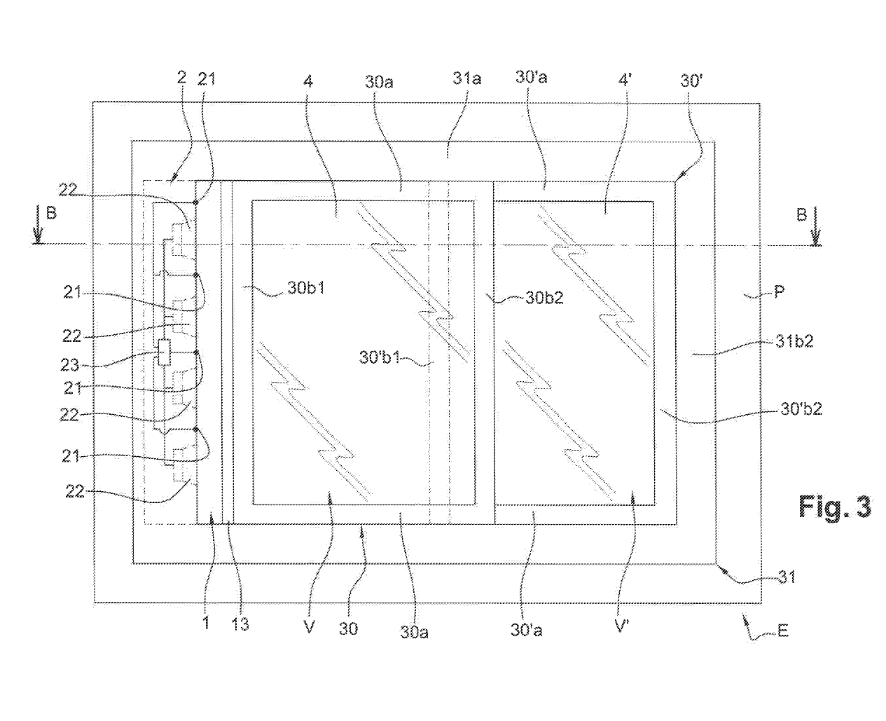

In an intermediate open position (FIGS. 3, 4 and 6), the lateral vertical profile 30b1 of the opening frame 30 moves away from the corresponding vertical profile 31b1 of the stationary frame 31, by a predetermined distance (for example between 2 cm and 15 cm, preferably 10 cm) when the leaf V slides. A natural ventilation remains possible between the inside and outside E the room L, by the window F.

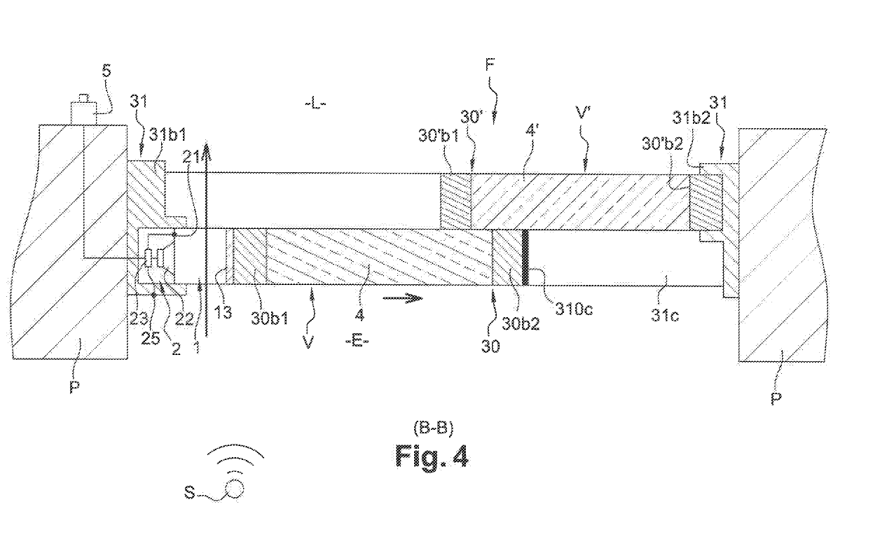

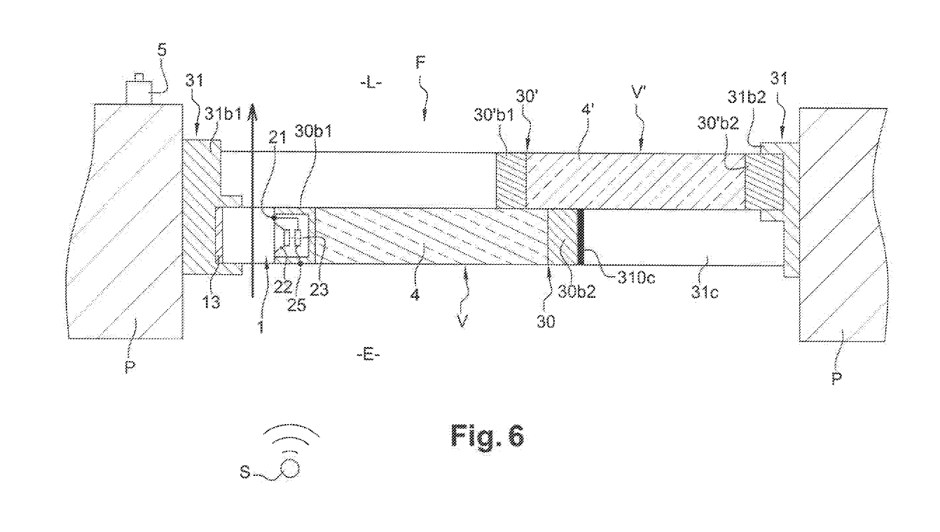

In this intermediate open position, the ventilation passage 1 is formed. It is delimited by the space that separates the lateral vertical profile 30b1 of the opening frame 30 from the corresponding vertical profile 31b1 of the stationary frame 31 when said opening frame 30 is in the intermediate open position. The passage 1 communicates between the outside E of the room L and the inside of said room in such a way as to allow natural ventilation between the outside E and inside of said room, over the entire height of the window F. This natural ventilation is diagrammed in the FIGS. 4 and 6 by the arrow drawn in the passage 1.

The width of the ventilation passage 1 corresponds to the sliding distance of the leaf V from the closed position to the intermediate open position, for example between 2 cm and 15 cm, preferably 10 cm. In the closed position, the ventilation passage 1 has a zero thickness. Any ventilation between the inside and outside E the room L by the ventilation passage 1 is prevented.

Given that the ventilation passage 1 is delimited by the profiles 30b1 and 31b1, it is not necessary to add an additional accessory that can reduce the total glazed surface of the window F and the lighting of the room L. Thanks to the invention, this total glazed surface and this lighting are fully preserved.

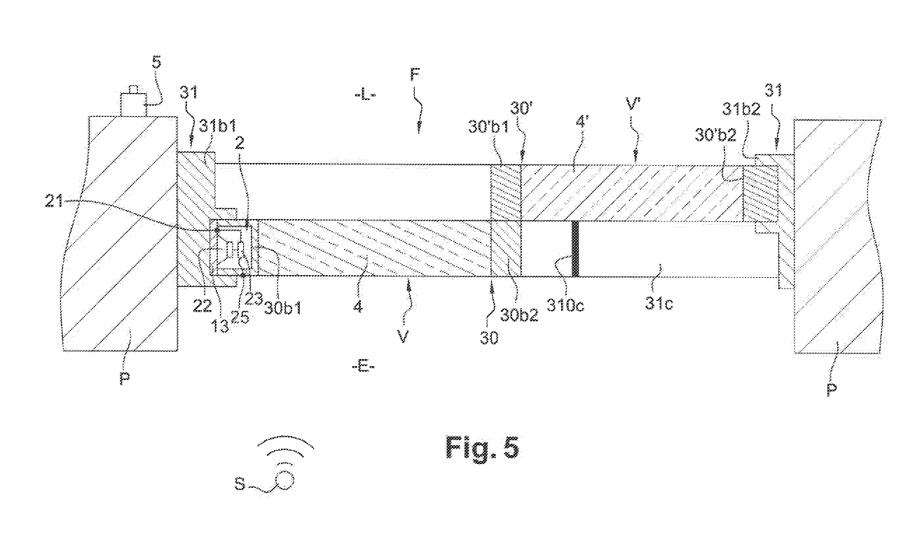

So that the user can easily reach the intermediate open position without opening the leaf V any further, it is advantageously provided to install in the rail 31c, an element 310c forming an abutment when the opening frame 30 is in the intermediate open position. This element 310c is clearly visible in the FIGS. 2 and 5 and has for example the form of a rib made of elastomer installed in the rail 31c. When the user wishes to open the leaf V further, it is sufficient for the user to slide said leaf with a moderate effort, in such a way that this rib made from elastomer is retracted under the opening frame 30. As such, when the opening frame 30 is in the open position, i.e. displaced beyond the intermediate open position (the profiles 30b1 and 31b1 being separated by a distance that is greater than the aforementioned predetermined distance), there is a natural ventilation between the inside and outside E the room L, in the same way as with an open conventional door or window.

A active noise absorber 2 is associated with the ventilation passage 1. This absorber is used for an active or passive control of the noise. It is directly incorporated into one of the profiles 30b1 or 31b1 mentioned hereinabove.

In the embodiment of FIGS. 1 to 4, the noise absorber 2 is directly installed in the first profile 31b1 of the stationary frame 31. In the embodiment of FIGS. 5 and 6, the noise absorber 2 is directly installed in the first profile 30b1 of the opening frame 30.

An active absorber 2 generates, in the ventilation passage 1, a sound level equivalent to the ambient sound level to be controlled, in particular a noise coming from a noise source located outside E of the room L. In practice, this active absorber 2 generates a counter-noise which is superimposed on the sound waves propagating in the ventilation passage 1.

The active noise absorber 2 can have the form of a piezoelectric actuator or a loudspeaker. Preferably use is made of a linear loudspeaker of the type described in U.S. Pat. No. 6,285,773 (Carme) mentioned hereinabove, and to which those skilled in the art can refer where applicable. This type of linear loudspeaker can indeed be housed easily in a reduced volume and in particular in a narrow space, while still having an output comparable to that of a conventional loudspeaker with conical membranes. The geometrical shape and the particular arrangement of the elements that comprise the linear loudspeaker offer a very satisfactory output. In particular, in light of the substantial length of the membrane, the latter displaces a large mass of air during its vibration, which allows for good output in the low frequencies. This linear loudspeaker is for example installed vertically over the entire length of the profile 30b1 or 31b1.

The linear loudspeaker can however be replaced with several circular loudspeakers 22 installed side-by-side over the entire length of the profile 30b1 or 31b1 as shown in FIGS. 1 and 3. It is possible for example to use ASCA loudspeakers marketed by the applicant.

Use will be made in the rest of the description of the generic term loudspeaker, bearing the reference 22, whether the latter is a loudspeaker as such (linear or circular) or a piezoelectric actuator.

The noise absorber 2 can include a single linear loudspeaker or several circular loudspeakers 22 arranged along the profile 30b1 or 31b1. An integration into the stationary frame 31 makes it possible to simplify the design of the absorber 2 and its wiring, The choice of the number of loudspeakers and of their arrangement depends on the sound field to be attenuated, by superposition, of the noises propagating in the ventilation passage 1, in order to increase the sound insulation as soon as the window is in the intermediate open position.

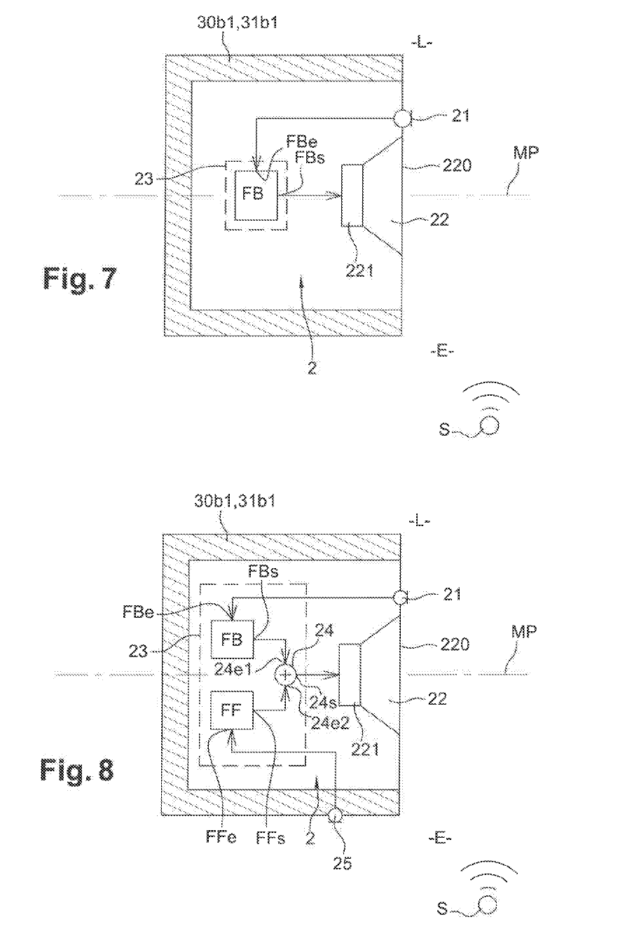

In FIG. 7, the loudspeaker 22 comprises a membrane 220 adapted to vibrate and generate a counter-noise in the ventilation passage 1. An actuator 221 is associated with the membrane 220. This actuator 221 is adapted for inducing a vibratory movement to the membrane 220. This can be a piezoelectric actuator or more conventionally an actuator using an arrangement of magnets and a coil electrically excited to cause the vibration of the membrane 220 which generates the counter-noise.

At least one microphone 21 is installed in the ventilation passage 1 in order to sense the acoustic signals propagating in the latter. By way of example it is possible to use a microphone of the PUI Audio brand bearing the reference POM-2246L-C33-R and manufactured by the company PUI Audio.

The microphone 21 sends a signal that represents the noise in the ventilation passage 1 to a control electronics 23. Then, the control electronics 23 emits a control signal to the actuator 221 according to the acoustic signals sensed by the microphone 21. The absorber 2 as such makes it possible to increase the sound insulation of the window F when it is in the intermediate open position.

The microphone 21 is advantageously a control microphone connected to the control electronics 23. This control microphone 21 is installed in the ventilation passage 1 in such a way that it is as far away as possible from the noise source S. Generally, the control microphone 21 is offset from the longitudinal median plane MP of the profile 30b1, 31b1 whereon it is installed, opposite the noise source S to be attenuated. In the example of FIGS. 7, 8 and 9, if the noise source S is the ambient noise present outside of the room L (for example the noise of vehicles circulating in a street or on a road, the noise of an aircraft engine, . . . ), the control microphone 21 is offset from the longitudinal median plane MP, towards the room L. If the noise source S is the ambient noise present inside the room L (for example the music from a discotheque), the control microphone 21 is offset from the longitudinal median plane MP, towards the outside E.

Thanks to this position of the control microphone 21, the applicant was able to surprisingly observe that the attenuation of the noise was effective and stable, in a relatively wide frequency band from 0 Hz to 650 Hz, and more particularly from 70 Hz to 650 Hz.

Good results are obtained when the control microphone 21 is oriented in a direction that is perpendicular to the direction of propagation, in the ventilation passage 1, of the acoustic signals coming from the noise source S. The control microphone 21 is as such oriented a direction which is parallel to the direction of displacement of the leaf V, i.e. parallel to the longitudinal median plane MP. In this arrangement, it appears that the control microphone 21 collects in a satisfactory manner the residual acoustic signal which is used as an error signal in the filtering by feedback described hereinafter in the description. This residual acoustic signal is a combination of the residual noise reaching the inside of the room L and of a counter-noise generated by the loudspeaker 22 which is ideally the inverted copy of the noise to be suppressed coming from the source S.

In FIGS. 7, 8 and 9, the control microphone 21 is installed on the same profile 30b1, 31b1 as that wherein is installed the loudspeaker 22. More particularly, the control microphone 21 is adjacent to the membrane 220. This configuration simplifies the design of the noise absorber 2 in that all of the elements that it is comprised of are grouped together into a single profile 30b1, 31b1.

The control microphone 21 can however be installed in the ventilation passage 1, on another profile which is distant from the profile 30b1, 31b1 wherein is installed the loudspeaker 22. The control microphone 21 can for example be arranged on the profile 30b1 of the opening frame 30 which is opposite the profile 31b1 of the stationary frame 31 wherein is installed the loudspeaker 22. The inverse configuration can of course be considered. The control microphone 21 can again be installed on one of the horizontal profiles 31a of the stationary frame, in the ventilation passage 1, while the loudspeaker 22 is installed on one of the vertical profiles 30b1 or 30b2, and inversely.

In FIG. 7, the control electronics 23 comprises a means of filtering via feedback FB of the non-adaptive type having an input FBe connected to the control microphone 21 and an output FBs connected to the actuator 11.

The technique of active attenuation by feedback is based on a counter-reaction loop arranged to generate an active attenuation of the sound waves propagating in the ventilation passage 1. The signal measured by the control microphone 21 is injected at the actuator 221 through the means of filtering via feedback FB which corrects said signal in order to attempt to cancel its energy. This feedback technique makes it possible to obtain an acoustic attenuation with a certain gain, without generating any instability in a treatment frequency band. Most often, this treatment frequency band corresponds to low frequencies, for example to sound waves at the frequency band ranging from 0 to 400 Hz and more particularly from 70 Hz to 400 Hz.

The control electronics 23 advantageously comprises: —preamplification means comprising an input connected to the control microphone 21 and an output connected to the input FBe of the means of filtering by feedback FB; —and amplification means comprising an input connected to the output FBs of the means of filtering by feedback FB, and an output connected to the actuator 221.

This control electronics 23 constitutes here a counter-reaction loop arranged to generate an active sound attenuation without generating any instability in a chosen frequency band. For example, the frequency band wherein the means of filtering via feedback FB is effective without generating any instability in Nyquist terms, is about from 0 to 650 Hz for the sound waves, and more particularly from 70 Hz to 650 Hz.

In practice, the means of filtering via feedback FB comprises a plurality of active analog filters of a magnitude greater than or equal to 1, arranged in order to generate a transfer function making it possible to prevent instabilities in the frequency band 0-650 Hz in Nyquist terms, more particularly in the band 70-650 Hz, and the transfer function of the means of filtering FB is determined in such a way that the phase of said transfer function does not pass through the value 0 in the band 0-600 Hz, and more particularly the band 70-600 Hz.

However, a pumping effect appears beyond 650 Hz which results in an increase in the level of noise in relation to the action of the passive means of attenuation alone, i.e. the panel 4 alone. This phenomenon is entirely known to those skilled in the art, and forms a non-linearity (degradations in performance) in relation to the expected results of the observation of the system in an open loop.

In order to overcome this, it is advantageous to combine the active attenuation by feedback with an active attenuation by feedforward. In FIG. 8, the control electronics 23 comprises for this purpose a means of filtering by feedforward FF, having an input FFe connected to a reference microphone 25 and an output FFs connected to the actuator 221.

By way of example it is possible to use a reference microphone 25 of the PUI Audio brand bearing the reference POM-2246L-C33-R and manufactured by the company PUI Audio.

In this technique of active attenuation by feedforward, a reference acoustic field, upstream of the propagation of the acoustic field in the ventilation passage 1, is detected by the reference microphone 25, the treated by the means of filtering FF in order to determine the control to be applied to the actuator 221.

In order to optimize the treatment of the signals, the following provided: —preamplification means comprising an input connected to the reference microphone 25 and an output connected to the input FFe of the means of filtering by feedforward FF; —and amplification means comprising an input connected to the output FFs of the means of filtering by feedforward FF, and an output connected to the actuator 221.

In FIG. 8, the control electronics 23 comprises a summing means 24 having: —a first input 24e1 connected to the output FBs of the means of filtering by feedback FB; —a second input 24e2 connected to the output FFs of the means of filtering by feedforward FF; —and an output 24s connected to the actuator 221. The output signal of the summing means 24 which is applied to the actuator 11 is as such a linear combination of the signals coming from the routes of filtering by feedback and by feedforward. Amplification means are advantageously provided comprising an input connected to the output 24s of the summing means 24, and an output connected to the actuator 221.

The technique by feedforward is articulated around the means of filtering by feedforward FF of the adaptive or non-adaptive type. Compared to a non-adaptive filtering, the adaptive filtering is more effective from a noise attenuation standpoint, but requires more substantial calculating power and a higher cost for realization.

In the case where the means of filtering via feedforward FF is of the non-adaptive type, the transfer function thereof is a fixed function that is preset and which does not vary.

With an adaptive means of filtering by feedforward FF, the transfer function is modified dynamically, continuously, by a real-time analysis algorithm of the acoustic signal coming from the source S. The coefficients of the means of filtering by feedforward FF are adapted in real time according to an algorithm chosen in such a way as to minimize the energy of the vibrations sensed by the control microphone 21 according to the energy of the reference vibrations sensed by the reference microphone 25.

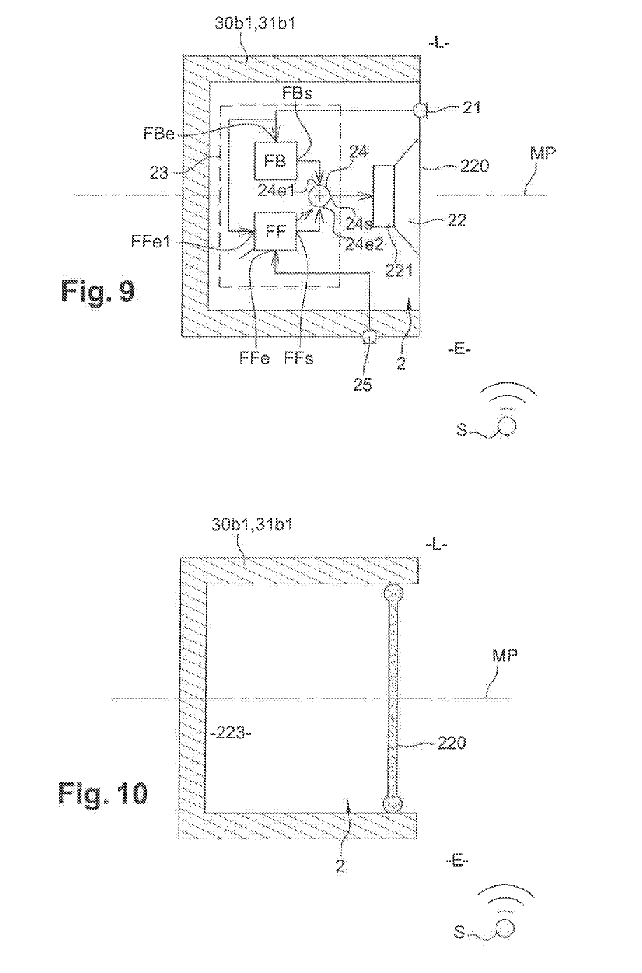

This adaptive filtering is diagrammed in FIG. 9 wherein the means of filtering via feedforward FF comprises: a first input FFe1 connected to the control microphone 21; and a second input FFe2 connected to the reference microphone 25. In practice, the means of filtering via feedforward FF comprises finite pulse response filters of the adaptive type. The coefficients of these filters are updated in real time by a minimization algorithm which takes account the signals sensed by the control microphone 21. For example, the minimization algorithm is of the least mean squares type (LMS) or more advantageously of the filtered-X least mean squares type (FXLMS).

In a prior step of initialization the transfer function of the so-called secondary path between the loudspeaker 22 and the control microphone 21 is measured, sampled, and saved in the memory of a processor of the control electronics 23. This transfer function measured as such beforehand will then be used in the calibration phase for the adaptation of the filtering elements by feedforward. This step is carried out in a manner known to those skilled in the art.

The active attenuation of the “hybrid” type obtained according to the invention is the result of a combination of the means of filtering by feedforward and by feedback wherein the filtering by feedforward is grafted onto the filtering by feedback or reciprocally. This makes it possible to linearize the feedback attenuation in all of a frequency band that is wider than the frequency band (0-650 Hz, and more particularly 70-650 Hz) treated directly by the means of filtering via feedback FB, to accelerate the convergence of the minimization algorithm, and to improve the robustness of the means of filtering by feedforward FF. As such the gain in attenuation is improved in a widened band which can range up to 4000 Hz, by suppression of the pumping effect mentioned hereinabove.

In FIGS. 8 and 9, the reference microphone 25 is installed on the same profile 30b1, 31b1 as the one in which the loudspeaker 22 is installed. Contrary to the control microphone 21, it is installed outside of the ventilation passage 1 and oriented towards the noise source S. The reference microphone 25 can as such optimally sense the copy of the noise to be suppressed coming from the source S and transmit this signal to the control electronics 23.

Good results are obtained when the reference microphone 25 is oriented in a direction that is parallel to the direction of propagation of the acoustic signals coming from the noise source S. The reference microphone 25 is as such oriented in a direction which is perpendicular to the direction of displacement of the membrane 220, i.e. perpendicular to the longitudinal median plane MP of the profile 30b1, 31b1. In this arrangement, it appears that the reference microphone 25 collects in a satisfactory manner the acoustic signal coming from the noise source S, without being disturbed by the counter-noise generated by the loudspeaker 22.

In order to simplify the design of the noise absorber 2, the reference microphone 25 and the control microphone 21 are carried by the same profile 30b1, 31b1. It can however be provided that the control microphone 21 and the reference microphone 25 are each carried by a separate profile. The reference microphone 25 can for example be arranged on the profile 30b1 of the opening frame 30 which is opposite the vertical profile 31b1 wherein are installed the loudspeaker 22 and the control microphone 21. It can also be installed on one of the horizontal profiles 31a of the stationary frame 31, while the loudspeaker 22 and the control microphone 21 are installed on one of the profiles 30b1, 31b1, and inversely.

Other assemblies can be considered such as those described in European patent EP0898774 (FRAUNHOFER) or in the American patent U.S. Pat. No. 6,963,647 (FRAUNHOFER), to which those skilled in the art can refer in case of need.

It is not necessary for the noise absorber 2 to be activated when the window F is in the closed position. To this effect, a switch is adapted to activate the noise absorber 2. In FIGS. 2, 4 5 and 6, the switch 5 has the form of a rocker switch or a push-button installed in the room L, on a wall P, which switch is of the type conventionally used for lighting. By manipulating this switch 5, the user can activate or deactivate the noise absorber 2, for example by controlling the electrical power supply of the control electronics 23.

In an alternative embodiment, it is provided that the switch be controlled by the movement of the window F in such a way that when said window passes from the closed position to the intermediate open position, said switch automatically activates the active noise absorber 2. To this effect, a position sensor can be installed in the rail 31c. When the window F is in the intermediate open position, the position sensor cooperates with the switch so that the latter automatically activates the active noise absorber 2. This switch can also be adapted to automatically deactivate the active noise absorber 2 when the window F is in the closed position or when it is not in the intermediate open position.

The absorber 2 can also be passive, i.e. it is adapted to absorb all or a portion of the sound waves propagating in the ventilation passage 1. To do this, the faces of the profiles 30b1, 31b1, 31a which are located in the ventilation passage 1 and which delimit said passage on these four sides, can be partially or entirely covered with a sound-insulation material. In FIGS. 2 and 4, the noise absorber 2 is installed in the profile 31b1 of the stationary frame 31. The face of the corresponding profile 30b1 of the opening frame 30, which is located facing the absorber 2, is covered with the sound-insulation material 13. In FIGS. 5 and 6 the noise absorber 2 is installed in the profile 30b1 of the opening frame 31. The face of the corresponding profile 31b1 of the stationary frame 31, which is located facing the absorber 2, is covered with the sound-insulation material 13.

In order to further improve the noise reduction in the ventilation passage 1, it is advantageous to combine an active attenuation through the use of the active absorber 2 and a passive attenuation by the covering 13.

In FIG. 10, the absorber 2 is passive. A flexible membrane 220 is simply suspended at the side walls of a cavity 223 arranged in the profile 30b1, 31b1. The membrane 220 closes the cavity 223 in such a way as to be able to vibrate in the ventilation passage 1. In this configuration, the membrane 220 absorbs all or a portion of the sound waves propagating in the ventilation passage 1, making it possible to increase the sound insulation. The membrane 220 is for example formed by a film with elastic properties, such as an elastomer having an elastic power or a polyethylene film.

The arrangement of the various elements and/or means and/or steps of the invention, in the embodiments described hereinabove, must not be understood as requiring such an arrangement in all of the implementations. In any case, it is understood that diverse modifications can be made to these elements and/or means and/or steps, without leaving the spirit and the scope of the invention. In particular:
The room L can be a particular compartment, such as the compartment of a motor vehicle, of a train, and even of an aircraft. The walls P are then for example formed from sheets.
The window F can include a single leaf V formed by the opening frame 30 mounted mobile in the stationary frame 31, or more than two leaves.
The two leaves V, V′ can be able to be displaced by laterally sliding in parallel planes on horizontal support rails mounted at the lower portion of the fixed stationary frame 31.
The leaf V can be displaced by vertically sliding over one or several vertical support rails mounted in the lateral portion of the stationary frame 31, and in particular in the vertical profiles 31b.
The frames 30 and 31 are preferably of rectangular or square shape, but can be of polygonal shape, have one or several curved edges, etc.
The natural ventilation in the passage 1 can be done from the outside of the room L towards the outside E; or from the inside of the room L to the outside E.
The element 310c forming an abutment can have any other form that suits those skilled in the art.
The ventilation passage 1 and the noise absorber 2 can be associated with a tilting window wherein the opening frame 30 is mounted movable in rotation in the stationary frame 31.
The filter by feedback FEEDBACK can be adaptive, by using for example an algorithm of the IMC-FXLMS type pour “Internal Model Control Filtered-X Least Mean Squares”.
Regarding the control algorithms in FEEDBACK and/or FEEDFORWARD mode, the treatment can be either analog or digital.
The filter by feedforward FEEDFORWARD can be used alone, without a filter by feedback FEEDBACK.

1-17. (canceled)

18. An apparatus for natural ventilation of a room, said apparatus comprising:
a room delimited by walls,
at least one door or one window installed in one of the room walls and comprises an opening frame produced from profiles supporting at least one glass panel, which opening frame is mounted so as to move in a fixed stationary frame formed by profiles surrounding said opening frame,
a ventilation passage which communicates between the outside of the room and the inside of the room in such a way as to allow natural ventilation between the outside and inside of said room,
a noise absorber capable of attenuating sound waves propagating in the ventilation passage, said attenuation being realized by the generation of a counter-noise which is superimposed on said sound waves,
the opening frame is mounted movably in the stationary frame between a closed position wherein a first profile of the opening frame is attached to the first corresponding profile of the stationary frame and an open position wherein the first profile of the opening frame is separated from the first profile of the stationary frame, wherein
in an intermediate open position of the opening frame, the first profile of the opening frame is separated from the first profile of the stationary frame by a predetermined distance,
the ventilation passage is delimited by the space separating the first profile of the opening frame from the first profile of the stationary frame when said opening frame is in the intermediate open position,
the noise absorber is directly installed in the first profile of the opening frame and/or in the first profile of the stationary frame,
when the opening frame is in the closed position, the first profiles are attached together in such a way that the ventilation passage is hermetically closed, with any ventilation between the inside and outside of the room by said ventilation passage being prevented.

19. The apparatus according to claim 18, wherein the first profiles are vertical profiles.

20. The apparatus according to claim 18, wherein:
the noise absorber is directly installed in the first profile of the stationary frame,
the first corresponding profile of the opening frame has a face which is located facing the noise absorber, which face is covered with a sound-insulating material.

21. The apparatus according to claim 18, wherein:
the noise absorber is directly installed in the first profile of the opening frame,
the first corresponding profile of the stationary frame has a face which is located facing the noise absorber, which face is covered with a sound-insulating material.

22. The apparatus according to claim 18, wherein the noise absorber includes at least one microphone arranged to sense the noise in the ventilation passage and at least one loudspeaker adapted to generate a counter-noise in the ventilation passage in response to the noise sensed by the microphone.

23. The apparatus according to claim 22, wherein a switch is adapted to activate the noise absorber.

24. The apparatus according to claim 23, wherein the switch is adapted to be controlled by the movement of the opening frame in such a way that when said opening frame passes from the closed position to the intermediate open position, said switch automatically activates the noise absorber.

25. The apparatus according to claim 23, wherein the switch is adapted to automatically deactivate the noise absorber when the opening frame is in the closed position.

26. The apparatus according to claim 22, wherein the microphone is installed on the same profile as the one in which the loudspeaker is installed, said microphone being adjacent to said loudspeaker.

27. The apparatus according to claim 22, wherein:
the microphone is a control microphone connected to a control electronics,
the control electronics is adapted to control the loudspeaker according to the acoustic signals sensed by the control microphone, which control electronics includes a means of filtering via feedback having an input connected to the control microphone and an output connected to the loudspeaker.

28. The apparatus according to claim 26, wherein the control microphone is offset from the longitudinal median plane of the profile whereon it is installed, opposite the noise source to be attenuated.

29. The apparatus according to claim 26, wherein the control microphone is oriented in a direction that is perpendicular to the direction of propagation, in the ventilation passage, of the acoustic signals coming from the noise source to be attenuated.

30. The apparatus according to claim 22, wherein:
at least one reference microphone is installed outside of the ventilation passage, which microphone is oriented towards the noise source,
the control electronics include a means of filtering via feedforward, having an input connected to the reference microphone and an output connected to the loudspeaker.

31. The apparatus according to claim 30, wherein the control microphone and the reference microphone are carried by the same profile or are each carried by a separate profile.

32. The apparatus according to claim 30, wherein:
the control electronics comprises a summing means having a first input, a second input and an output connected to the loudspeaker,
the means of filtering via feedback includes an input connected to the control microphone and an output connected to the first input of the summing means,
the means of filtering via feedforward includes an input connected to the reference microphone and an output connected to the second input of the summing means.

33. The apparatus according to claim 30, wherein the means of filtering via feedforward is of the adaptive type and includes:
a first input connected to the control microphone,
a second input connected to the reference microphone.

34. The apparatus according to claim 30, wherein the loudspeaker is a circular loudspeaker or a linear loudspeaker.
